(19) United States
(12) Patent Application Publication
(10) Pub. No.: US 2023/0296100 A1
(43) Pub. Date: Sep. 21, 2023

(54) HVAC SYSTEM HAVING MULTIPLE BLOWER MOTORS AND A SHARED MOTOR CONTROLLER

(71) Applicant: Goodman Manufacturing Company, L.P., Waller, TX (US)

(72) Inventors: Michael F. Taras, Spring, TX (US); Santosh Nerur, Katy, TX (US)

(21) Appl. No.: 17/697,571

(22) Filed: Mar. 17, 2022

(51) Int. Cl. F04D 25/06; F24F 7/02; F24F 11/63; F04D 19/00; F04D 17/08; H02P 23/14

(52) U.S. Cl. CPC F04D 25/06; F24F 7/02; F24F 11/63; F04D 19/002; F04D 17/08; H02P 23/14

(57) ABSTRACT

An HVAC with multiple blowers and a shared motor controller is provided. In one embodiment, an HVAC system includes a first blower installed within a cabinet. The first blower has a motor and a fan connected to be driven by the motor of the first blower. The HVAC system further includes a second blower installed within the cabinet. The second blower also includes a motor and a fan connected to be driven by the motor of the second blower. A motor controller is connected to control operation of both the motor of the first blower and the motor of the second blower. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

Modern residential and industrial customers expect indoor spaces to be climate controlled. In general, heating, ventilation, and air conditioning (“HVAC”) systems circulate an indoor space's air over low-temperature (for cooling) or high-temperature (for heating) sources, thereby adjusting the indoor space's ambient air temperature. HVAC systems generate these low- and high-temperature sources by, among other techniques, taking advantage of a well-known physical principle: a fluid transitioning from gas to liquid releases heat, while a fluid transitioning from liquid to gas absorbs heat. Within a typical HVAC system, a fluid refrigerant circulates through a closed loop of tubing that uses a compressor and other flow-control devices to manipulate the refrigerant's flow and pressure, causing the refrigerant to cycle between the liquid and gas phases. Generally, these phase transitions occur within the HVAC's heat exchangers, which are part of the closed loop and designed to transfer heat between the circulating refrigerant and flowing ambient air.

In some instances, a HVAC system is a split system having indoor and outdoor units, each having a heat exchanger, connected in fluid communication. As would be expected in such cases, the heat exchanger providing heating or cooling to the climate-controlled space or structure is described adjectivally as being “indoors,” and the heat exchanger transferring heat with the surrounding outdoor environment is described as being “outdoors.” The refrigerant circulating between the indoor and outdoor heat exchangers—transitioning between phases along the way—absorbs heat from one location and releases it to the other. Those in the HVAC industry describe this cycle of absorbing and releasing heat as “pumping.” To cool the climate-controlled indoor space, heat is “pumped” from the indoor side to the outdoor side. And the indoor space is heated by doing the opposite, pumping heat from the outdoors to the indoors.

In some other instances, a packaged HVAC system is a self-contained unit including two heat exchangers (e.g., an evaporator coil and a condenser coil), a blower, a compressor, and a refrigerant circuit installed in a shared cabinet. A packaged HVAC system can be installed at any suitable location but is often installed outside, such as on the ground or on the roof of a building. Heated or cooled air is provided from the packaged HVAC system to the indoor space of a building, such as through a supply duct, and air is drawn from the indoor space to the packaged HVAC system, such as through a return duct.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Certain embodiments of the present disclosure generally relate to air circulation assemblies in HVAC systems. More specifically, some embodiments relate to HVAC systems having multiple blowers that share a motor controller. In one example, an HVAC system includes two blowers, each having a motor for driving a fan to generate airflow, and a shared motor controller controls operation of the motors of both blowers. Further, in at least some instances, the shared motor controller synchronizes the motors for consistent operation. Some other embodiments include more than two blowers that are controlled by a shared motor controller. Such blowers and motor controllers may be installed in packaged systems, split systems, or any other suitable HVAC systems.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 illustrates schematically an HVAC system for heating and cooling indoor spaces within a structure, in accordance with one embodiment of the present disclosure;

FIG. 2 is a schematic process-and-instrumentation drawing of an HVAC system for heating and cooling indoor spaces within a structure, in accordance with one embodiment;

FIG. 3 generally depicts a packaged HVAC system having blowers, heat exchangers, and other components in a shared cabinet in accordance with one embodiment;

FIG. 4 is a block diagram of an air circulation assembly of an HVAC system, the air circulation assembly including two blowers and a shared motor controller, in accordance with one embodiment;

FIG. 5 depicts two blowers and a motor controller installed in a cabinet of an HVAC system in accordance with one embodiment;

FIG. 6 is a block diagram of an air circulation assembly like that of FIG. 4, but in which the shared motor controller is incorporated into a motor of one of the blowers, in accordance with one embodiment;

FIG. 7 is a block diagram of an air circulation assembly like that of FIG. 4, but in which the assembly includes more than two blowers that share the motor controller, in accordance with one embodiment; and

FIG. 8 is a block diagram of a motor control system with a control stage and power stages for operating motors of an HVAC system in accordance with one embodiment.

### DETAILED DESCRIPTION OF SPECIFIC EMBODIMENTS

Specific embodiments of the present disclosure are described below. In an effort to provide a concise description of these embodiments, all features of an actual implementation may not be described. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

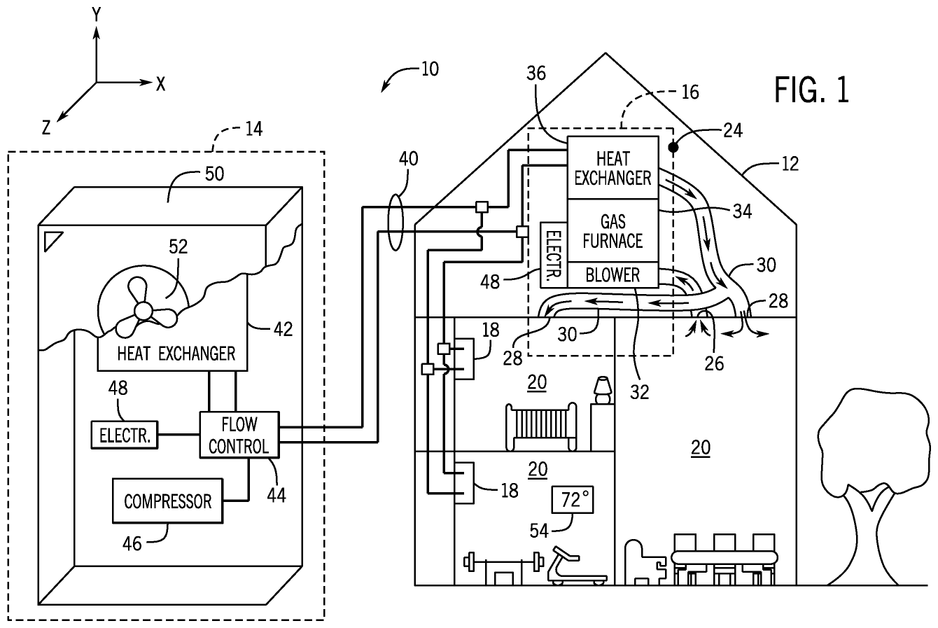

By way of example, and turning now the figures, FIG. 1 illustrates a split HVAC system 10 in accordance with one embodiment. As depicted, the system 10 provides heating and cooling for a residential structure 12. But the concepts disclosed herein are applicable to a myriad of heating and cooling situations, including industrial and commercial settings. And while some HVAC systems provide each of heating, ventilation, and air conditioning, others do not. The term “HVAC system,” as used herein, means a system that provides one or more of heating, ventilation, air conditioning, or refrigeration. For example, an air conditioner that does not provide heating or ventilation is considered an HVAC system. The use of the term “HVAC” in describing a system, unit, component, equipment, etc., herein is not to be interpreted as a requirement that each of heating, ventilation, and air conditioning is provided.

Many North American residences, as well as some commercial and industrial buildings, employ “ducted” systems, in which a structure's ambient air is circulated over a central indoor heat exchanger and then routed back through relatively large ducts (or ductwork) to multiple climate-controlled indoor spaces. However, the use of a central heat exchanger can limit the ducted system's ability to vary the temperature of the multiple indoor spaces to meet different occupants' needs. This is often resolved by increasing the number of separate systems within the structure—with each system having its own outdoor unit that takes up space on the structure's property, which may not be available or at a premium.

Some buildings also or instead employ “ductless” systems, in which refrigerant is circulated between an outdoor unit and one or more indoor units to heat and cool specific indoor spaces. Unlike ducted systems, ductless systems route conditioned air to the indoor space directly from the indoor unit—without ductwork.

The described HVAC system 10 of FIG. 1 is a split system with two primary portions: the outdoor unit 14, which mainly comprises components for transferring heat with the environment outside the structure 12; and the indoor units 16 & 18, which mainly comprise components for transferring heat with the air inside the structure 12. In the illustrated structure, a ducted indoor unit 16 and ductless indoor units 18 provide heating and cooling to various indoor spaces 20.

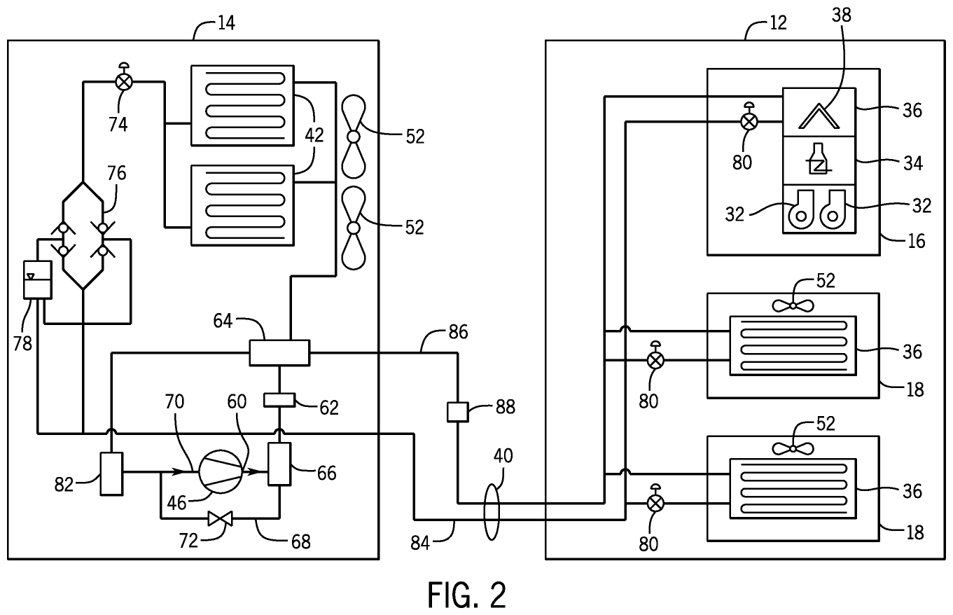

Focusing on the ducted indoor unit 16, it has an air-handler unit (or AHU) 24 that provides airflow circulation, which in the illustrated embodiment draws ambient indoor air via a return vent 26, passes that air over one or more heating/cooling elements (i.e., sources of heating or cooling), and then routes that conditioned air, whether heated or cooled, back to the various climate-controlled spaces 20 through supply vents 28. As depicted in FIG. 1, air between the AHU 24 (which may also be referred to as an air handler) and the vents 26 and 28 is carried by ducts or ductwork 30, which are relatively large pipes that may be rigid or flexible. A blower 32 provides the motivational force to generate airflow and circulate the ambient air through the vents 26 and 28, AHU 24, and ducts 30. Although a single blower 32 can be used to circulate air, in other instances (such as shown in FIG. 2) multiple blowers 32 are used.

As shown, the ducted indoor unit 16 is a “dual-fuel” system that has multiple heating elements. A gas furnace 34, which may be located downstream (in terms of airflow) of the blower 32, combusts natural gas to produce heat in furnace tubes (not shown) that coil through the furnace. These furnace tubes act as a heating element for the ambient indoor air being pushed out of the blower 32, over the furnace tubes, and into supply ducts 30 to supply vents 28. In other instances, the furnace 34 is an electric furnace, with one or more heat strips or other electric heating elements for heating air passing through the AHU 24, rather than a gas furnace. Whether gas or electric, the furnace 34 is generally operated when robust heating is desired. During conventional heating and cooling operations, air from the blower 32 is routed over an indoor heat exchanger 36 and into the supply ducts 30.

The blower 32, furnace 34, and indoor heat exchanger 36 may be packaged as an integrated AHU, or those components may be modular. Moreover, it is envisaged that the positions of the furnace, indoor heat exchanger, and blower can be reversed or rearranged. Internal components of the blower 32, the furnace 34, and the indoor heat exchanger 36 can be positioned within one or more casings, cabinets, or other housings (integrated or modular).

The indoor heat exchanger 36—which in this embodiment for the ducted indoor unit 16 is an A-coil 38 (FIG. 2), as it known in the industry—can act as a heating or cooling element that adds or removes heat from the structure by manipulating the pressure and flow of refrigerant circulating within and between the A-coil 38 and the outdoor unit 14 via refrigerant lines 40.

In the illustrated embodiment of FIG. 1, the state of the A-coil 38 (i.e., absorbing or releasing heat) is the opposite of the outdoor heat exchanger 42. More specifically, if heating is desired, the illustrated indoor heat exchanger 36 acts as a condenser, aiding transition of the refrigerant from a high-pressure gas to a high-pressure liquid and releasing heat in the process. And the outdoor heat exchanger 42 acts as an evaporator, aiding transition of the refrigerant from a low-pressure liquid to a low-pressure gas, thereby absorbing heat from the outdoor environment. If cooling is desired, the outdoor unit 14 has flow-control devices 44 that reverse the flow of the refrigerant—such that the outdoor heat exchanger 42 acts as a condenser and the indoor heat exchanger 36 acts as an evaporator. The outdoor unit 14 also contains other equipment—like a compressor 46, which provides the motivation for circulating the refrigerant, and electrical control circuitry 48, which provides command and control signals to various components of the system 10.

The outdoor unit 14 is a side-flow unit that houses, within a plastic or metal casing or housing 50, the various components that manage the refrigerant's flow and pressure. This outdoor unit 14 is described as a side-flow unit because the airflow across the outdoor heat exchanger 42 is motivated by a fan that rotates about an axis that is non-perpendicular with respect to the ground. In contrast, “up-flow” devices generate airflow by rotating a fan about an axis generally perpendicular to the ground. (As illustrated, the Y-axis is perpendicular to the ground.) In one embodiment, the side-flow outdoor unit 14 may have a fan 52 that rotates about an axis that is generally parallel to the ground. (As illustrated, the X- and Z-axes are parallel to the ground.) It is envisaged that either up-flow or side-flow units could be employed. Advantageously, the side-flow outdoor unit 14 provides a smaller footprint than traditional up-flow units, which are more cubic in nature.

In addition to the ducted indoor unit 16, the illustrated HVAC system has ductless indoor units 18 that also circulate refrigerant, via the refrigerant lines 40, between the outdoor heat exchanger 42 and the ductless indoor unit's heat exchanger. The ductless indoor units 18 may work in conjunction with or independent of the ducted indoor unit 16 to heat or cool the given indoor space 20. That is, the given indoor space 20 may be heated or cooled with the structure's air that has been conditioned by the ductless indoor unit 18 and by the air routed through the ductwork 30 after being conditioned by the A-coil 38, or it may be entirely conditioned by the ductless indoor unit or the ducted indoor unit working independent of one another. As another embodiment, the A-coil refrigerant loop may be operated to provide cooling or heating only—and the ductless indoor units may also be designed to provide cooling or heating only.

As is well known, the HVAC system may be in communication with a thermostat 54 that senses the indoor space's temperature and allows the structure occupants to “set” the desired temperature for that sensed indoor space. The thermostat may operate using a simple on/off protocol that sends 24V signals, for example, to the HVAC system to either activate or deactivate various components; or it may be a more complex thermostat that uses a “communicating protocol,” such as ClimateTalk or a proprietary protocol, that sends and receives data signals and can provide more complex operating instructions to the HVAC system.

FIG. 2 provides further detail about the various components of an HVAC system and their operation. The compressor 46 draws in gaseous refrigerant and pressurizes it, sending it into the closed refrigerant loop 40 via compressor outlet 60. (A flow meter 62 may be used to measure the flow of refrigerant out of the compressor.) The outlet 60 is connected to a reversing valve 64, which may be electronic, hydraulic, or pneumatic and which controls the routing of the high-pressure gas to the indoor or outdoor heat exchangers. Moreover, the outlet 60 may be coupled to an oil separator 66 that isolates oil expelled by the compressor and, via a return line 68, returns the separated oil to the compressor inlet 70—to help prevent that expelled oil from reaching the downstream components and helping ensure the compressor maintains sufficient lubrication for operation. The oil return line 68 may include a valve 72 that reduces the pressure of the oil returning to the compressor 46.

To cool the structure, the high-pressure gas is routed to the outdoor heat exchangers 42, where airflow generated by the fans 52 aids the transfer of heat from the refrigerant to the environment—causing the refrigerant to condense into a liquid that is at high-pressure. As shown, the outdoor unit 14 has multiple heat exchangers 42 and fans 52 connected in parallel, to aid the HVAC system's operation.

The refrigerant leaving the heat exchangers 42 is or is almost entirely in the liquid state and flows through or bypasses a metering device 74. From there, the high-pressure liquid refrigerant flows into a series of receiver check valves 76 that manage the flow of refrigerant into the receiver 78. The receiver 78 stores refrigerant for use by the system and provides a location where residual high-pressure gaseous refrigerant can transition into liquid form. The receiver may be located within the casing 50 of the outdoor unit or may be external to the casing 50 of the outdoor unit (or the system may have no receiver at all). From the receiver 78, the high-pressure liquid refrigerant flows to the indoor units 16, 18, specifically to metering devices 80 that restrict the flow of refrigerant into each heat exchanger of the indoor units 16, 18, to reduce the refrigerant's pressure. The refrigerant leaves the indoor metering devices 80 as a low-pressure liquid (or mostly liquid). In the described embodiment, the metering device 80 is an electronic expansion valve, but other types of metering devices—like capillaries, thermal expansion valves, reduced orifice tubing—are also envisaged. Electronic expansion valves provide precise control of refrigerant flow into the heat exchangers of the indoor units, thus allowing the indoor units—in conjunction with the compressor—to provide individualized cooling for the given indoor space 20 the unit is assigned to.

Low-pressure liquid refrigerant is then routed to the indoor heat exchangers 36. As illustrated, the indoor heat exchanger 36 for the ducted indoor unit 16 is an “A-coil” style heat exchanger 38. But the heat exchanger 38 can be an “N-coil” (or “Z-coil”) style heat exchanger or a slab coil or can take any other suitable form. Airflow generated by the blower 32 aids in the absorption of heat from the flowing air by the refrigerant, causing the refrigerant to transition from a low-pressure liquid to a low-pressure gas as it progresses through the indoor heat exchanger 36. And the airflow generated by the blower 32 drives the now cooled air into the ductwork 30 (specifically the supply ducts), cooling the indoor spaces 20. In a similar fashion, the low-pressure liquid refrigerant is routed to the indoor heat exchangers 36 of the ductless indoor units 18, where it is evaporated, causing the refrigerant to absorb heat from the environment. However, unlike the ducted indoor unit, the ductless indoor units circulate air without ductwork, using a local fan 52, for example.

The refrigerant leaving the indoor heat exchangers 36, which is now entirely or mostly a low-pressure gas, is routed to the reversing valve 64 that directs refrigerant to the accumulator 82. Any remaining liquid in the refrigerant is separated in the accumulator, ensuring that the refrigerant reaching the compressor inlet 70 is almost entirely in a gaseous state. The compressor 46 then repeats the cycle, by compressing the refrigerant and expelling it as a high-pressure gas.

For heating the structure 12, the process is reversed. High-pressure gas is still expelled from the compressor outlet 60 and through the oil separator 66 and flow meter 62. However, for heating, the reversing valve 64 directs the high-pressure gas to the indoor heat exchangers 36. There, the refrigerant—aided by airflow from the blower 32 or the fans 52—transitions from a high-pressure gas to a high-pressure liquid, rejecting heat. And that heat is driven by the airflow from the blower 32 into the ductwork 30 or by the fans 52 in the ductless indoor units 18, heating the indoor spaces 20. If more robust heating is desired, the gas furnace 34 may be ignited, either supplementing or replacing the heat from the heat exchanger. That generated heat is driven into the indoor spaces by the airflow produced by the blower 32. In other instances, electric heating elements (e.g., of an electric furnace 34 of the indoor units 16 or 18) may also or instead be used to provide heat to the indoor spaces 20.

The high-pressure liquid refrigerant leaving each indoor heat exchanger 36 is routed through or past the given metering valve 80, which is, in this embodiment, an electronic expansion valve. But for other embodiments, the valve may be any other type of suitable expansion valve, like a thermal expansion valve or capillary tubes, for example. Using the refrigerant lines 40, the high-pressure liquid refrigerant is routed to the receiver check valves 76 and into the receiver 78. As described above, the receiver 78 stores liquid refrigerant and allows any refrigerant that may remain in gaseous form to condense. From the receiver, the high-pressure liquid refrigerant is routed to an outdoor metering device 74, which lowers the pressure of the liquid. Just like the indoor metering device 80, the illustrated outdoor metering device 74 is an electrical expansion valve. But it is envisaged that the outdoor metering device could be any number of devices, including capillaries, thermal expansion valves, reduced orifice tubing, for example.

The lower-pressure liquid refrigerant is then routed to the outdoor heat exchangers 42, which are acting as evaporators. That is, the airflow generated by the fans 52 aids the transition of low-pressure liquid refrigerant to a low-pressure gaseous refrigerant, absorbing heat from the outdoor environment in the process. The low-pressure gaseous refrigerant exits the outdoor heat exchanger 42 and is routed to the reversing valve 64, which directs the refrigerant to the accumulator 82. The compressor 46 then draws in gaseous refrigerant from accumulator 82, compresses it, and then expels it via the outlet 60 as high-pressure gas, for the cycle to be repeated.

As illustrated in FIG. 2, the system is a “two-pipe” variable refrigerant flow system, in which the HVAC system's refrigerant is circulated between the outdoor and indoor units via two refrigerant lines 40, one of which is a line that carries predominantly liquid refrigerant (a liquid line 84) and one of which is a line that carries predominately gas refrigerant (a gas line 86). However, it is also envisaged that, in other embodiments, aspects described herein could be applied to a three-pipe variable refrigerant flow system, in which in addition to the gas and liquid lines a third discharge line aids in the circulation of refrigerant.

In many instances, the structure 12 may have had a previous HVAC system with pre-existing refrigerant piping at least partially built into the structure's interior walls. For example, the pre-existing system may be a traditional HVAC unit that uses circulating refrigerant for cooling only and a gas furnace for heating, with all of the conditioned air delivered to the interior spaces via the ductwork. And the pre-existing refrigerant lines—which are built into the walls of the structure—may have a gas line with a 6/8-inch, ⅞-inch, or 9/8-inch outer diameter gas line. However, in certain embodiments, the outdoor unit 14 may have more modern refrigerant piping, which tends to be smaller in outer diameter. For example, the outdoor unit 14 may be 2-, 3-, or 4-Ton unit that has a gas line diameter of ⅝ inch. It would be laborious and cost ineffective to replace the pre-existing gas line in the structure with ⅝-inch diameter tubing. Accordingly, the illustrated HVAC system includes a coupler 88 that helps couple the varying diameter gas lines to one another. For example, the coupler 88 may facilitate coupling of the outdoor unit's ⅝-inch diameter gas line to the structure's pre-existing 6/8-inch, ⅞-inch, or 9/8-inch diameter gas line. In another embodiment, the outdoor unit 14 may be a 5-Ton unit with a gas line having a diameter of 6/8 inch. The coupler could facilitate coupling of this outdoor unit with a pre-existing gas line of ⅞-inch or 9/8-inch diameter.

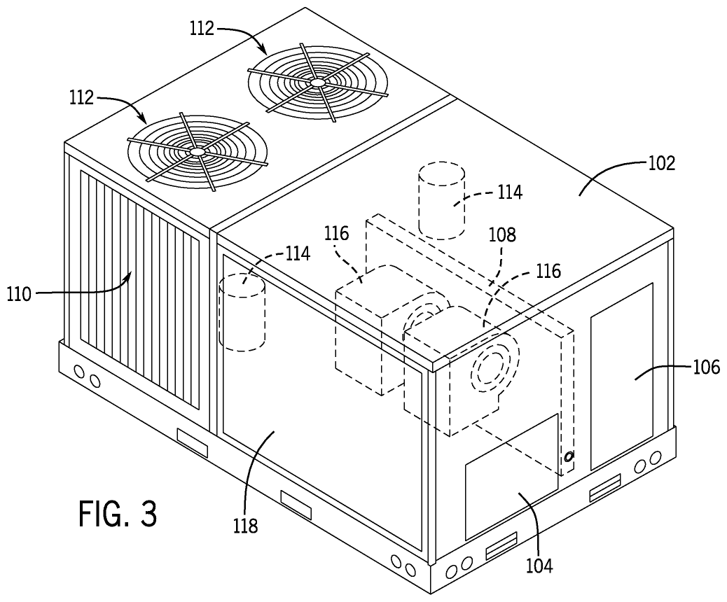

In another embodiment depicted in FIG. 3, a packaged HVAC system includes various components housed in a shared cabinet 102. The packaged system can output conditioned air (e.g., heated or cooled air) from a supply duct opening 104 and draw air into the cabinet 102 via a return duct opening 106. Ductwork can be connected between a structure and the openings 104 and 106 to circulate air between the packaged system and the structure.

Heat exchangers 108 and 110 within the cabinet 102 facilitate heat transfer and allow ambient air received through the return duct opening 106 to be treated (e.g., heated or cooled) and supplied to the structure via the supply duct opening 104. The packaged system can include multiple heat exchangers 110, and fan vents 112 facilitate heat transfer and airflow from the cabinet 102 to the surrounding environment. The heat exchanger 108 is an evaporator coil and the heat exchanger 110 is a condenser coil in at least some instances. Like described above with respect to the split system 10, fluid refrigerant is circulated through and between the heat exchangers 108 and 110 to cause the refrigerant to cycle between the liquid and gas phases and transfer heat with ambient air.

It will be appreciated that other components are also installed within the cabinet 102, such as compressors 114, blowers 116, and tubing for routing the refrigerant between the compressors 114 and the heat exchangers 108 and 110. The blowers 116 generate airflow through the heat exchanger 108, which can condition the air via heat transfer, such as described above. Although two compressors 114 and two blowers 116 are depicted in FIG. 3, the packaged system can include any suitable number of compressors 114 and blowers 116 in other instances. The cabinet 102 can also include any suitable number of access panels 118 to facilitate access to internal components within the cabinet 102.

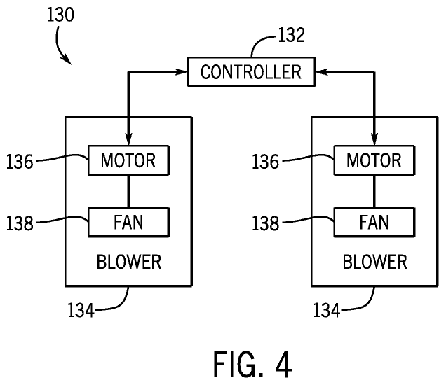

In some cases, an HVAC system has multiple blowers (e.g., blowers 32 or 116) and each blower has its own motor controller. In some embodiments, however, an HVAC system with multiple blowers includes a shared controller that controls motors, and thus operation, of multiple blowers. In FIG. 4, for instance, an air circulation assembly 130 of an HVAC system includes a single motor controller 132 shared by two blowers 134.

The air circulation assembly 130 can be used in various HVAC systems. In some embodiments, the blowers 134 are used as the blowers 32 (FIG. 2) installed in a cabinet of the AHU 24 or as the blowers 116 (FIG. 3) installed in the cabinet 102. The motor controller 132 connected to control the blowers 134 can also be installed within the cabinet of the AHU 24, within the cabinet 102, or at any other suitable location.

Each of the blowers 134 includes a motor 136 connected to drive a fan 138 to circulate air through the HVAC system. The blowers 134 and their components can take any suitable form. In some embodiments, each fan 138 is a scroll cage fan, an axial fan, or a tangential fan. Each motor 136 may be a three-phase alternating current (AC) motor, a single-phase AC motor, or a direct current (DC) motor. In at least one embodiment, each of the motors 136 is a direct-drive motor, which directly drives rotation of the connected fan 138 without intervening transmission elements, such as belts, pulleys, or gears.

The motor controller 132 is connected to control operation of the motor 136 of each blower 134. More specifically, the motor controller 132 can regulate the electrical power delivered to the motors 136 to control their operation, such as to control one or more of the speed, torque, or rotational position of each motor 136. The motors 136 may be operated in any suitable running mode, such as a constant torque mode or a constant rotational speed (e.g., revolutions-per-minute) mode.

In at least some embodiments, a single motor controller 132 synchronizes the motors 136 of multiple blowers 134 during running of an HVAC system to facilitate consistent operation. Further, in some instances the shared motor controller 132 continually monitors rotation of the motors 136 and maintains synchronization of the multiple blowers 134 during operation to reduce or avoid uneven loading or slippage between the motors 136. Additionally, the single motor controller 132 may be programmed or otherwise configured to synchronize the rotational positions of the motors 136 so that motors 136 that are out of phase (e.g., at motor start-up) can be brought into operation at the same phase.

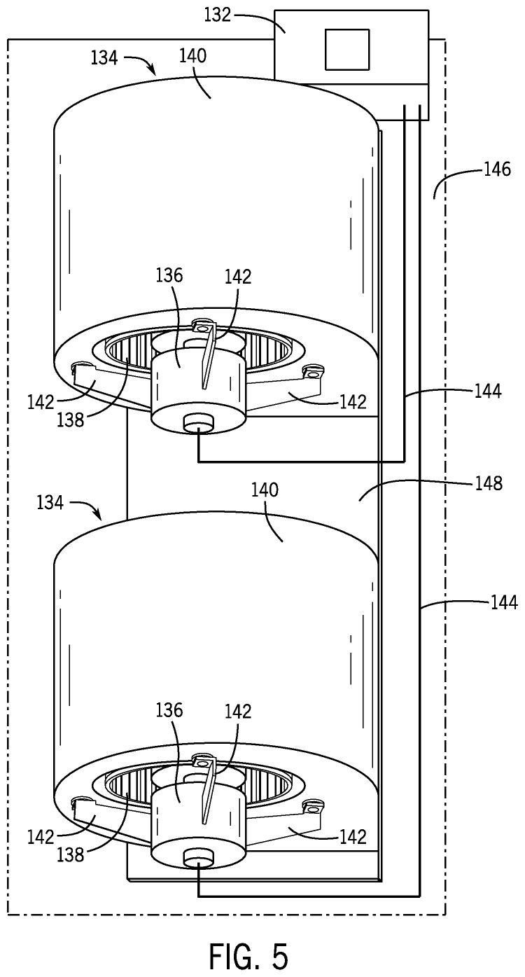

By way of example, the motor controller 132 and the blowers 134 of an HVAC system are shown in FIG. 5 in accordance with one embodiment. As noted above, each blower 134 includes a motor 136 connected to drive a fan 138. In this example, each fan 138 is installed within a fan housing 140 that directs airflow generated by the fan 138 during operation. The motors 136 can be mounted in any suitable manner and are shown in FIG. 5 fastened to the fan housings 140 via support legs 142.

The motor controller 132 is connected in communication with the motors 136 via one or more lines 144, such as cables or wires. Although only generally represented in FIG. 5 for clarity, the lines 144 may include multiple cables, wires, or other lines that electrically connect the motor controller 132 to a motor 136. The lines 144 may be used for either or both of power and data communication between the controller 132 and a motor 136. The motors 136 in FIG. 5 are electrically connected to the motor controller 132 in parallel, such that the motor controller 132 can control each motor 136 through an independent communication pathway.

The motor controller 132 and the blowers 134 may be installed at any suitable location and in any suitable manner in an HVAC system. In FIG. 5, for instance, the motor controller 132 is shown mounted on a shelf or panel 146, such as an interior panel in the cabinet 102 of a packaged HVAC system or in a cabinet of the AHU 24. The blowers 134 could be mounted on the same surface as the motor controller 132 (e.g., the panel 146) or on some other surface. As depicted in FIG. 5, the blowers 134 are mounted on a shared mounting plate 148 received by the panel 146. This arrangement may facilitate installation and removal of the blowers 134 together as a subassembly from an HVAC cabinet.

The blowers 134 can be installed in parallel, such as in FIG. 5, with each blower 134 operating independently to generate airflow. In other instances, the blowers 134 could be installed in series, such that airflow passes through the blowers 134 in sequence during operation (i.e., airflow generated from one blower 134 is routed to the suction side of another blower 134).

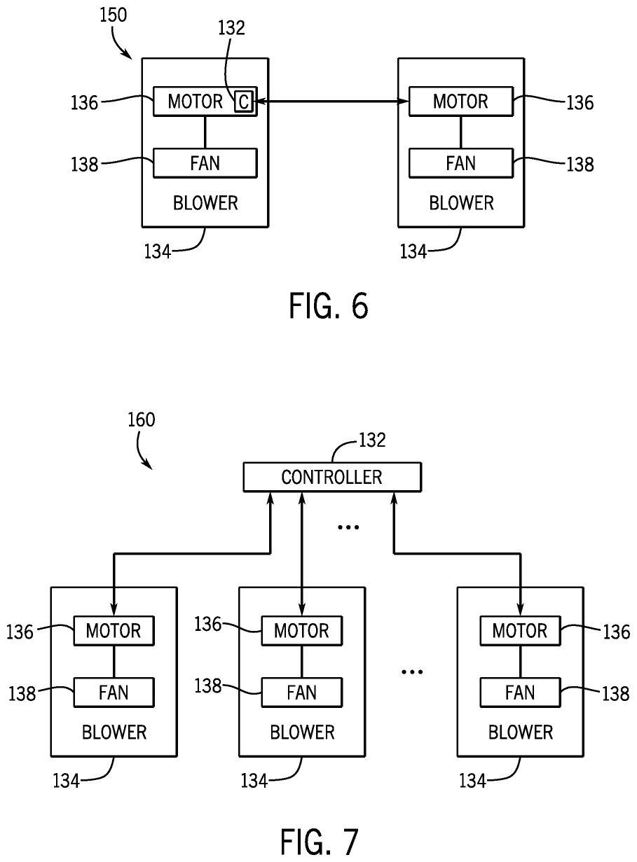

The motor controller 132 is installed apart from the motors 136 in some instances, including as shown in FIG. 5. In other embodiments, however, the motor controller 132 may be incorporated into a blower 134, such as within a motor 136 of the blower 134. One example of this is generally shown in FIG. 6, in which an air circulation assembly 150 includes the motor controller 132 incorporated within the motor 136 of one of the blowers 134.

While certain examples above are described as having a motor controller 132 shared by two blowers 134, it is again noted that the motor controller 132 may control more than two blowers 134 in other embodiments. In FIG. 7, for instance, an air circulation assembly 160 has the motor controller 132 shared by three or more blowers 134. Each of the blowers 134 may be installed within an HVAC system (e.g., in a cabinet). The motor controller 132 is connected to control operation of each of the motors 136 of the blowers 134 and can synchronize operation of the blowers 134, as discussed above.

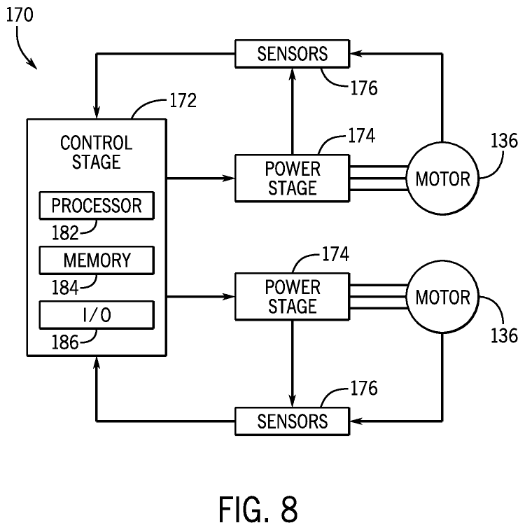

The motor controller 132 can take any suitable form. In an embodiment depicted in FIG. 8, for example, a control system 170 includes a control stage 172 and power stages 174. The control stage 172 generates control signals that regulate power delivery from the power stages 174 to the motors 136 and, thus, control operation of the blowers 134 of the HVAC system. In at least some embodiments, each power stage 174 includes circuitry (e.g., gate drivers and transistors) for controlling power delivery to an attached motor 136 in response to command signals from the control stage 172. The control stage 172 can deliver command signals to each power stage 174 independently to facilitate individual control of each motor 136.

Sensors 176 are installed in the HVAC system (e.g., in the cabinet 102 or the cabinet of the AHU 24) to detect operational parameters for the blowers 134. Examples of these sensors 176 include motor current sensors, voltage sensors, position sensors (e.g., Hall-effect sensors), angular encoders, and temperature sensors. The sensors 176 provide operating information to the control stage 172 and may be used in synchronizing the motors 136, such as described above.

Although the control stage 172 may take other forms, in FIG. 8 the control stage 172 is depicted as having a processor 182, a memory 184, and an input—output interface 186. In at least some embodiments, the processor 182, the memory 184, and the input—output interface 186 are integrated into a single microcontroller chip. Control logic may be provided as application instructions stored in the memory 184 and executed by the processor 182 for controlling operation of the motors 136. This may include operating the motors 136 and synchronizing the motors 136, such as described above. While only two motors 136 are shown in FIG. 8, more than two motors 136 could be operated and synchronized via the control system 170 in other embodiments. The input—output interface 186 facilitates communication between the control stage 172 and other components, such as the power stages 174, the sensors 176, and another controller (e.g., a main controller) of the HVAC system.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. An HVAC system comprising:
a first blower installed within a cabinet, the first blower having a motor and a fan connected to be driven by the motor of the first blower;
a second blower installed within the cabinet, the second blower having a motor and a fan connected to be driven by the motor of the second blower; and
a motor controller connected to control operation of both the motor of the first blower and the motor of the second blower.

2. The HVAC system of claim 1, wherein the motor controller is incorporated in the motor of the first blower or in the motor of the second blower.

3. The HVAC system of claim 1, wherein the motor controller is installed apart from the motor of the first blower and from the motor of the second blower.

4. The HVAC system of claim 1, wherein the fan of the first blower and the fan of the second blower are each a scroll cage fan, an axial fan, or a tangential fan.

5. The HVAC system of claim 1, wherein the motor of the first blower and the motor of the second blower are direct-drive motors.

6. The HVAC system of claim 1, comprising at least one additional blower installed within the cabinet.

7. The HVAC system of claim 6, wherein the at least one additional blower installed within the cabinet has a motor and a fan connected to be driven by the motor of the at least one additional blower, and the motor controller is connected to control operation of each of the motor of the first blower, the motor of the second blower, and the motor of the at least one additional blower.

8. The HVAC system of claim 1, wherein the motor controller is configured to synchronize the motor of the first blower and the motor of the second blower.

9. The HVAC system of claim 8, wherein the motor controller is configured to continually monitor rotation of the motor of the first blower and the motor of the second blower and to maintain synchronization of the motor of the first blower and the motor of the second blower during operation of the first blower and the second blower.

10. The HVAC system of claim 1, comprising a heat exchanger, wherein the first blower and the second blower are arranged to cause air to flow through the heat exchanger during operation of the first blower and the second blower.

11. The HVAC system of claim 10, wherein the heat exchanger is installed within the cabinet.

12. The HVAC system of claim 1, comprising a compressor.

13. The HVAC system of claim 12, wherein the HVAC system includes a packaged HVAC unit with the compressor, the first blower, and the second blower installed within the cabinet.

14. The HVAC system of claim 12, wherein the HVAC system includes a split system in which the compressor is installed in a different cabinet than the first blower and the second blower.

15. An HVAC system comprising:
a cabinet;
a plurality of blowers installed within the cabinet to force air through the cabinet, wherein each blower of the plurality of blowers includes a blower motor; and
a motor controller shared by each blower of the plurality of blowers to control operation of the blower motor of each blower.

16. The HVAC system of claim 15, wherein the plurality of blowers includes a first blower and a second blower that are installed in parallel within the cabinet.

17. The HVAC system of claim 15, wherein the motor controller is configured to operate the blower motor of each blower in a constant rotational speed mode or a constant torque mode.

18. The HVAC system of claim 15, comprising sensors installed in communication with the motor controller to provide operational data to the motor controller.

19. A method comprising:
operating a motor of a first blower of an HVAC system to generate airflow;
operating a motor of a second blower of the HVAC system to generate airflow; and
using a motor controller of the HVAC system to synchronize operation of the motor of the first blower and the motor of the second blower, wherein the motor controller is a single motor controller shared by the motor of the first blower and the motor of the second blower.

20. The method of claim 19, comprising:
determining an operating parameter of the motor of the first blower; and
based on the determined operating parameter, generating a command signal from the motor controller to vary operation of the motor of the first blower.

21. The method of claim 20, wherein determining the operating parameter of the motor of the first blower includes using a sensor to determine the operating parameter of the motor of the first blower and generating the command signal from the motor controller to vary operation of the motor of the first blower includes automatically generating the command signal from the motor controller in response to the determined operating parameter.

22. The method of claim 21, wherein using the sensor to determine the operating parameter of the motor of the first blower includes using a motor current sensor, a voltage sensor, a position sensor, an angular encoder, or a temperature sensor to determine the operating parameter of the motor of the first blower.

23. The method of claim 19, wherein operating the motor of the first blower of the HVAC system to generate airflow includes operating the motor of the first blower of the HVAC system to generate airflow of conditioned air into an indoor space of a structure.
